(19) United States
(12) Patent Application Publication
(10) Pub. No.: US 2007/0285230 A1
(43) Pub. Date: Dec. 13, 2007

(54) Device to help people locate their vehicles fast

(76) Inventor: Julia Karen Anglin, Warren, NJ (US)

Correspondence Address: Ms. Julia K. Anglin, 186 Mountain Avenue, Warren, NJ, 07059, US

(21) Appl. No.: 11/414,811

(22) Filed: Jun. 8, 2006

(51) Int. Cl. G08B 1/08; B60R 25/10

(52) U.S. Cl. 340/539.32; 340/426.19

(57) ABSTRACT

The JayVigator Car Locator is a small light weight pocket sized remote control device that will locate your vehicle when parked. The remote control is made of plastic. Powered by batteries. Have rubber push buttons and a LCD screen. The remote can also be carried on a key ring.

The remote control (front view) has a key ring. A LCD screen—For Visual reference. 10 Digit Access Code buttons—to activate the remote to your specific vehicle. 3 Atmosphere buttons—To specify the area in which the vehicle is parked. A Locate button—for the remote to locate the vehicle and a speaker to hear voice directions or the beeping sounds when in close proximity of the vehicle.

The (side view) has a Headphone Jack—for headphone access for privacy to hear voice directions or beep tones discretely.

The (back view) has a Partially Covered Panic button. A Beep/Vibrate switch—To indicate vibration or beep sounds to be heard or felt when in close proximity of the vehicle. A Battery Door and Voice/Silent switch to hear voice directions.

A electronic control module would have to be installed behind the dash board in the vehicle to transmit various related functions via the remote control device described above.

Have you ever been to the mall or shopping for groceries and upon leaving these places with all your hearts desires with the feeling of accomplishment when suddenly . . . as you look in to the parking lot a feeling of shame and disappointment enters your body as you wonder, “Now where did I park my car”?. Your looking around at a sea of cars and trucks and for some strange reason you feel like most of the vehicles in the lot look like yours. So you wander around with a look of dismay on you face holding bags of shopping or pushing a cart saying to yourself “I know I parked the car over here” or “Maybe I parked over there”.

Maybe you went to the airport to drop someone off for a flight or even pick someone up. You're excited to see your family member, friend or guest. Their just as equally happy to see you, you embrace then you say “let's go”. You walk out into the parking lot, reached into your pocket, wallet, or purse to discover you lost your parking ticket, and you know the rest people . . . embarrassment, disappointment, security guards driving you around asking you a thousand times “Have seen you car yet”?. You feel like a total donkey.

Maybe that's not the case for you, maybe your just forgetful like me sometimes with all things you've accomplished in life, the medication you may or may not are taking has taken it's toll on your mind.

Just a few things for you to think about because I too have experienced these same obstacles and embarrassing moments in life . . . . But don't worry!!

This is why I came up with this idea to create something especially for myself and all people who have gone though the same or similar times in their lives. Yes people there's still hope!!

Yes people it's here! A small, thin but very helpful friend you can carry in your pocket, on a key chain that has the answers to all our car finding needs. The Jay Vigator Car Locator is a device I created and designed to help us all.

As I mentioned before it's a small device that actually helps you find your vehicle. It has buttons for most of your vehicle-finding needs.

Use your 4-8 digit access code to activate your Jay Vigator Car Locator then push the locate button to locate your vehicle “It's that simple”.

The Jay Vigator Car Locator has a switch for voice navigation as well as silent for privacy, for an easy secure access to your vehicle. It also vibrates or signals you with a few short beeps to let you know when your close to you vehicle.

The Jay Vigator Car Locator also has buttons for you to find your vehicle in Parking Lots, Parking decks or even if you've parked on a Side Street or Parking Meter, saving you time to get those coins in the meter before the meter maid or man comes with those annoying and costly tickets.

I also would like to add Door Lock and Unlock plus Trunk Release buttons, so the consume would have fast and easy access their vehicles, but I don't know if this disqualifies me from obtaining a Utility Patent if possible. For I know these buttons have already been invented. Therefore I would not add these features, because I would really like to obtain a Utility Patent for this invention I have created.

This idea of mine was first thought of Jul. 20, 20005 I have hand drawn pictures to prove it. For legal reasons, I would also like to state that Rupert Anglin and Trevor Anglin are witnesses to my invention and the date it was thought of.

Thank You! And I am eagerly looking for forward to hearing from you.

Julia Anglin.

### BRIEF DESCRIPTIONS OF DRAWING

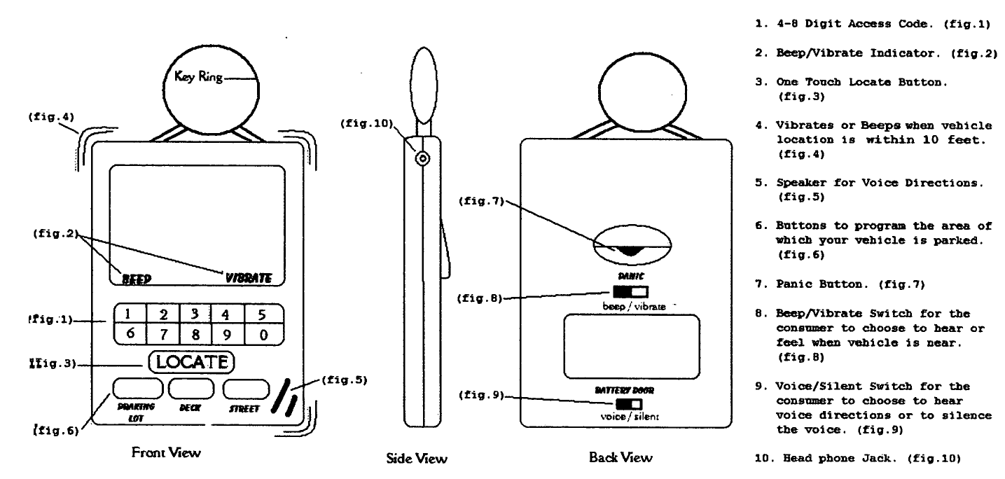

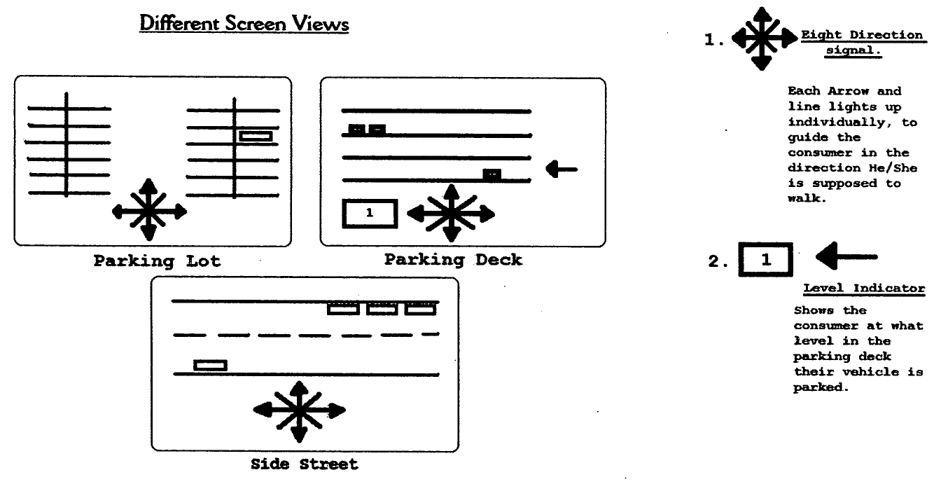

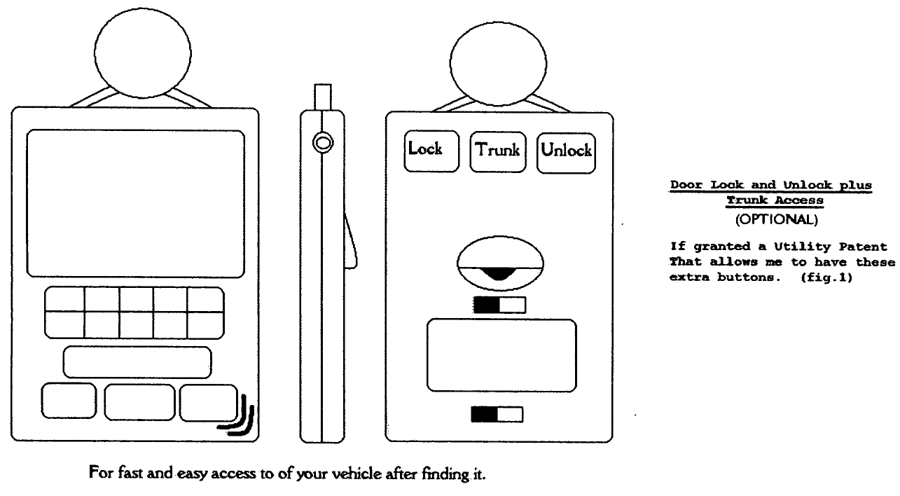

1. (FIG. 1.) 10 Digit Access Code Buttons—For consumer to put in a 4-8 digit access code to activate remote control to their specific vehicle.

2. (FIG. 2.) Beep/Vibrate Indicator—To show the consumer how They've chosen to be notified that they are within 10 feet of their Vehicle.

3. (FIG. 3.) A One Touch Locate Button—For the remote to locate parked vehicle.

4. (FIG. 4.) Vibrates—When within 10 feet of your vehicle.

5. (FIG. 5.) Speaker—To hear voice directions or beep sounds.

6. (FIG. 6.) Three Atmosphere Buttons—To indicate the area in Which vehicle is parked.

7. (FIG. 7.) Partially Covered Panic Button—To activate panic sounds (car horn honks) in case needed. Partially covered to prevent accidental activation of the panic button.

8. (FIG. 8.) Beep/Vibrate Switch—To indicate how consumer wants To be notified that they are within 10 feet from vehicle.

9. (FIG. 9.) Voice/Silent Switch—For consumer to indicate to hear Voice directions.

10. (FIG. 10.) Headphone Jack—For consumer to hear voice directions or beep tones discretely.

1. I Julia Karen Anglin state a claim to a small remote control device that helps people locate their vehicles in parking lots, decks and Side streets.
